(19) United States
(12) Patent Application Publication
(10) Pub. No.: US 2026/0039509 A1
(43) Pub. Date: Feb. 5, 2026

(54) SIGNAL PROCESSING CIRCUIT AND SIGNAL PROCESSING METHOD

(71) Applicant: Realtek Semiconductor Corp., HsinChu (TW)

(72) Inventor: Fengxiang Wang, Suzhou City (CN)

(73) Assignee: Realtek Semiconductor Corp., HsinChu (TW)

(21) Appl. No.: 19/206,068

(22) Filed: May 13, 2025

(30) Foreign Application Priority Data
Aug. 5, 2024 (CN) 202411066876.6

(51) Int. Cl. H04L 25/02; H04L 43/08

(52) U.S. Cl. CPC H04L 25/0202; H04L 43/08

(57) ABSTRACT

A signal processing circuit includes a channel estimation device, a data processing circuit and a false path detection circuit. The channel estimation device estimates transmission paths of a received signal based on a preamble portion of the received signal to generate channel parameter information. The data processing circuit processes a data portion of the received signal according to the channel parameter information to generate a data demodulation result associated with each transmission path. The false path detection circuit determines a characteristic value based on the data demodulation result associated with each transmission path, determines whether corresponding transmission path is a false path according to the characteristic value and the channel parameter information, and updates the channel parameter information to generate updated channel parameter information in response to the corresponding transmission path being determined as a false path. The updated channel parameter information does not comprise information regarding the false path.

### BACKGROUND OF THE INVENTION

### 1. Field of the Invention

The invention relates to a signal processing method, more particularly a signal processing method for identifying false transmission paths which are misidentified due to interference signals from other users among multiple identified transmission paths.

### 2. Description of the Prior Art

The Ultra-Wideband (UWB) technology of the Institute of Electrical and Electronics Engineers (IEEE) 802.15.4a/f/z standard is a wireless communication technology that utilizes nanosecond-level narrow pulses for data transmission.

A UWB Physical (PHY) Protocol Data Unit (PPDU) consists of two portions: the preamble portion and the data portion. For UWB systems, the preamble portion does not carry user-level characteristics, which means that when multiple devices coexist, there may be more than one device transmitting the same preamble signal. If the signal received by a local user equipment contains signals belonging to other users, which are interference signals for the local user equipment, the transmission paths belonging to the other users will be determined as the transmission paths of the local user equipment during the channel estimation process. For the local user equipment, the transmission paths belonging to the other users are actually false paths (false transmission paths), also known as virtual paths or invalid paths.

If the content of the preamble signals is the same and the symbol periods are also the same, it is difficult to suppress the virtual paths caused by interference from the other users through a combination processing of multiple symbols in the preamble portion. Therefore, a novel signal processing method is needed to identify and exclude virtual paths from multiple identified transmission paths to improve the reception performance of the local user equipment.

### SUMMARY OF THE INVENTION

According to an embodiment of the invention, a signal processing circuit comprises a channel estimation device, a data processing circuit, and a false path detection circuit. The channel estimation device estimates a plurality of transmission paths of a received signal based on a preamble portion of the received signal to generate channel parameter information. The channel parameter information comprises information regarding the transmission paths. The data processing circuit processes a data portion of the received signal according to the channel parameter information to generate a data demodulation result associated with each transmission path. The false path detection circuit determines a characteristic value of each transmission path based on the data demodulation result associated with the transmission path, determines whether the transmission path is a false path according to the characteristic value of the transmission path and the channel parameter information, and in response to the transmission path being determined as the false path, updates the estimated channel parameter information to generate updated channel parameter information and provides the updated channel parameter information to the data processing circuit. The updated channel parameter information does not comprise information regarding the transmission path being determined as the false path.

According to an embodiment of the invention, a signal processing method comprises: estimating a plurality of transmission paths of a received signal based on a preamble portion of the received signal to generate channel parameter information, wherein the channel parameter information comprises information regarding the transmission paths; processing a data portion of the received signal according to the channel parameter information to generate a data demodulation result associated with each transmission path; determining a characteristic value of each transmission path based on the data demodulation result associated with the transmission path; determining whether the transmission path is a false path according to the characteristic value of the transmission path and the channel parameter information; and in response to the transmission path being determined as the false path, updating the channel parameter information to generate updated channel parameter information. The updated channel parameter information does not comprise information regarding the transmission path being determined as the false path.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a PPDU format based on the IEEE 802.15.4a standard.

FIG. 2 shows four PPDU formats based on the IEEE 802.15.4z standard.

FIG. 3 shows a schematic diagram of a signal processing circuit according to an embodiment of the invention.

FIG. 4 shows a schematic diagram of the packet structure of the preamble portion and data portion according to an embodiment of this invention.

FIG. 5 shows an exemplary flow chart of a signal processing method according to an embodiment of the invention.

FIG. 6 shows another exemplary flow chart of a signal processing method according to an embodiment of the invention.

FIG. 7 shows a schematic diagram of a failure scenario.

FIG. 8 shows a schematic diagram of a scenario where the proposed signal processing method is applied to identify false paths due to interference signals from other users.

FIG. 9 shows another schematic diagram of a scenario where the proposed signal processing method is applied to identify false paths due to interference signals from other users.

### DETAILED DESCRIPTION

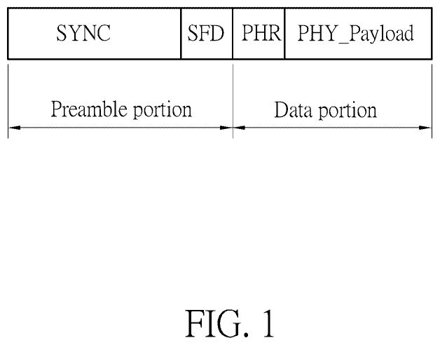

FIG. 1 shows a PPDU format based on the IEEE 802.15.4a standard. The PPDU comprises a preamble portion and a data portion. The preamble portion comprises a synchronization header consisting of a synchronization (SYNC) segment and a Start-of-Frame Delimiter (SFD). The data portion comprises a physical (PHY) header (PHR) and a physical payload (or simply called payload) (PHY_Payload), where the physical payload PHY_Payload is the valid data carried in the packet.

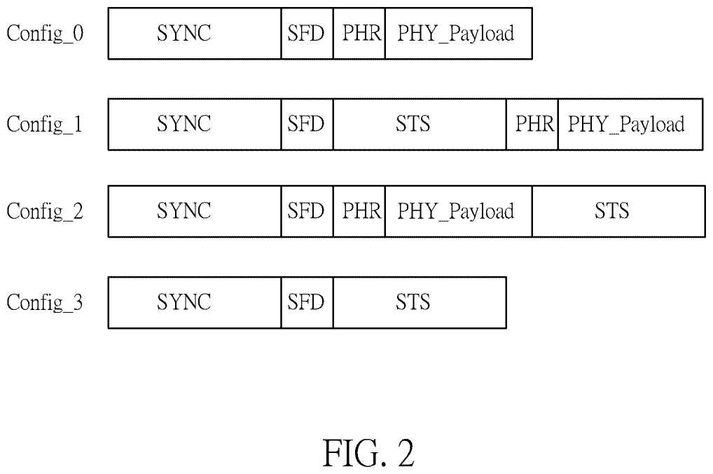

FIG. 2 shows four PPDU formats based on the IEEE 802.15.4z standard, including four packet configurations Config_0, Config_1, Config_2, and Config_3 depicted from top to bottom. The 802.15.4z standard introduces a Scrambled Timestamp Sequence (STS). The STS is a sequence scrambled with a key known only to the target user, and different users have different STSs, thus allowing the use of STS to exclude false paths from identified transmission paths. However, not all packet configurations contain STS. For example, configuration Config_0 in the 802.15.4z standard does not contain STS, and the PPDU in the 802.15.4a standard also does not contain STS. Additionally, although configuration Config_2 in the 802.15.4z standard contains STS, the STS is arranged after the physical header (hereinafter referred to as PHR) and the physical payload (hereinafter referred to as PHY_Payload). Even if STS can be utilized to exclude false paths from identified transmission paths, the processing of the data portion cannot benefit from the results of using STS to exclude false paths in a timely manner.

To solve the problem that false paths cannot be effectively excluded from the identified transmission paths in existing technology, a signal processing method capable of identifying and excluding false paths from multiple identified transmission paths is proposed. The proposed signal processing method is applicable to the formats without STS or to the formats with STS which is arranged after the PHR and PHY_Payload, and effectively improves the reception performance of the local user equipment. For convenience of explanation, the proposed method will be introduced in the following paragraphs based on the exemplary UWB system in compliance with the 802.15.4 series standard protocol. However, it should be noted that the scope of application of the invention is not limited to only the 802.15.4 series.

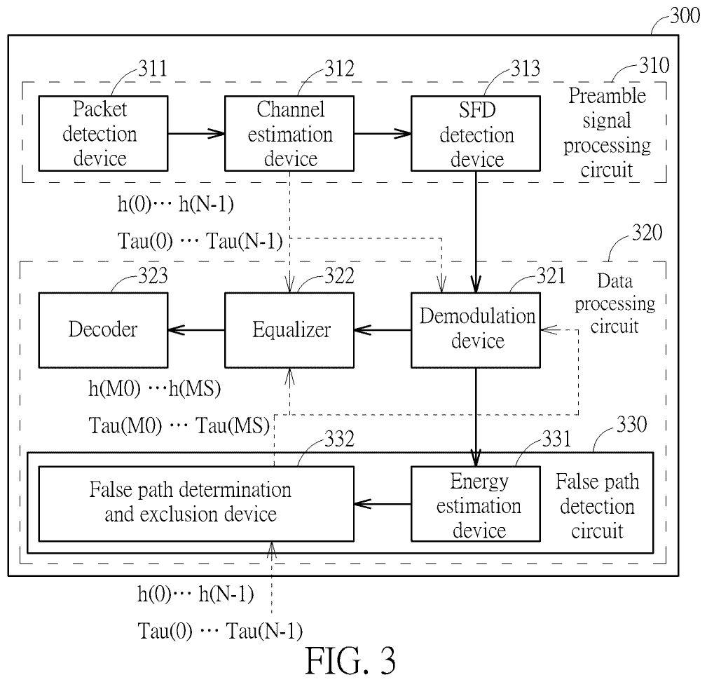

FIG. 3 shows a schematic diagram of a signal processing circuit according to an embodiment of the invention. The signal processing circuit 300 may comprise a preamble signal processing circuit 310, a data processing circuit 320, and a false path detection circuit 330. The false path detection circuit 330 may be comprised in the data processing circuit 320, but the invention is not limited thereto. In the embodiments of the invention, the false path detection circuit 330 is capable of effectively identifying and excluding false paths caused by interference from other users by using the data portion of the PPDU (e.g., the PHR or PHY_Payload shown in FIG. 1 or FIG. 2).

In a UWB system, the basic processing flow of a received signal in the local user equipment (i.e., the receiver) comprises: existence detection, time-frequency offset estimation, channel estimation, SFD detection, PHR demodulation and equalization, and PHY_Payload demodulation and equalization.

More specifically, the preamble signal processing circuit 310 may comprise a packet detection device 311, a channel estimation device 312, and a SFD detection device 313. The packet detection device 311 detects whether a packet exists in the received signal. In one embodiment of the invention, the receiver may store a reference sequence, and the packet detection device 311 may perform correlation calculations on the reference sequence and the received signal and determine whether a packet to the local user equipment exists in the received signal based on the calculation results, thereby performing the existence detection. If a packet to the local user equipment exists in the received signal, when the timing of the reference sequence aligns with the timing of the SYNC segment in the packet, a peak will appear in the calculation result, and this peak corresponds to a transmission path. If multiple peaks appear in the calculation result, it indicates that multiple transmission paths may exist between the transmitter and the receiver.

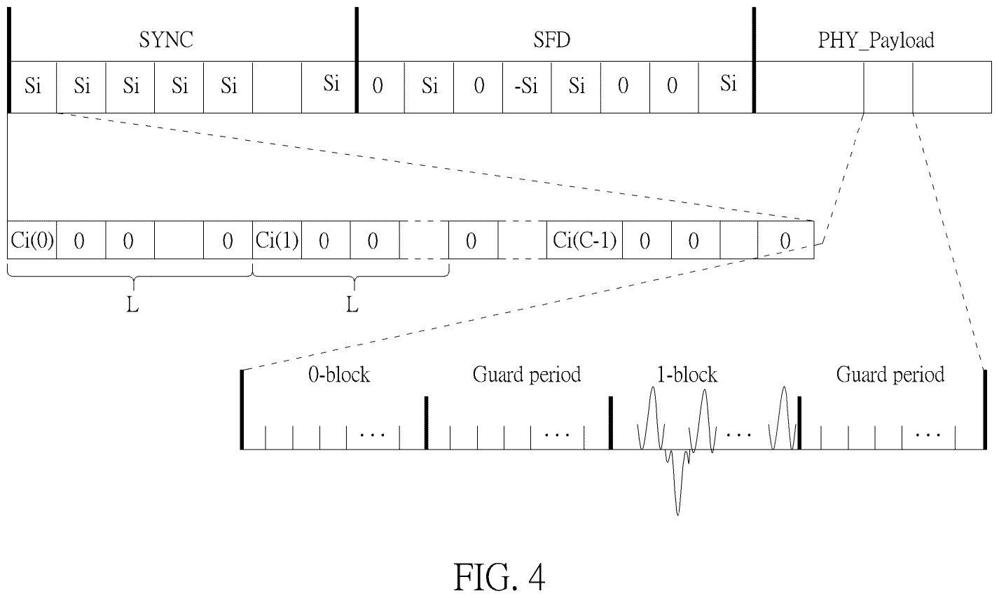

FIG. 4 shows a schematic diagram of the packet structure of the preamble portion and data portion according to an embodiment of this invention. In UWB systems, to reduce the complexity of synchronization, the SYNC segment is composed of periodically repeated symbols Si, and there are no additional modulation codewords on the symbols. A symbol Si may contain a sequence of ternary codes (e.g., containing three values: −1, 0, and 1), such as the sequence {Ci(0), Ci(1), . . . , Ci(C−1)} shown in FIG. 4, and the content and length of the ternary code sequence can be obtained through the value of code index (CodeIndex). The symbols Si of the SYNC segment are obtained by inserting zeros between the ternary codes in the ternary code sequence corresponding to a specific code index.

More specifically, each code index corresponds to a predefined ternary code sequence and supported channels. The content and length of the ternary code sequence can be obtained by looking up a known ternary code table using the code index. Additionally, (L−1) zeros are inserted between adjacent ternary codes based on the length L to extend the symbol period. Therefore, the code index (CodeIndex) and length (L) determine the composition of a symbol Si in the preamble portion. In an embodiment of the invention, the reference sequence stored by the receiver can be a ternary code sequence generated locally based on known code index (CodeIndex) and length (L).

Referring back to FIG. 3, the packet detection device 311 may perform correlation calculations on the reference sequence and the received signal, and may determine information regarding a transmission path, such as channel impulse response or time delay, based on the position of the peak. Alternatively, the packet detection device 311 may provide the peak detection results to the channel estimation device 312, for the channel estimation device 312 to estimate an impulse response corresponding to each transmission path. For example, assuming N transmission paths are identified based on the peak detection results, the channel estimation device 312 may perform time-frequency offset estimation and channel estimation to further estimate the channel impulse responses h(0) . . . h(N−1) and time delays Tau(0) . . . . Tau(N−1) corresponding to these transmission paths, where N is a positive integer. In one embodiment of the invention, the channel parameter information generated by the channel estimation device 312 may comprise the channel impulse responses h(0) . . . h(N−1) and time delays Tau(0) . . . . Tau(N−1) respectively corresponding to the currently identified N transmission paths.

The preamble signal processing circuit 310 may use the SYNC segment to complete operations of synchronization, channel estimation, and initial time-frequency offset estimation. Then, the SFD detection device 313 detects the SFD in the received signal based on a specific modulation code. Taking FIG. 4 as an example, the SFD may comprise 8 Si symbols, and the modulation code is {0, 1, 0, −1, 1, 0, 0, 1}. When the SFD sequence is detected using the known modulation code, the end of the preamble portion of the received signal can be determined based on the SFD boundary, and the boundary of the data portion, for example, the start position of the PHR which stores information such as the data rate and length of the PHY_Payload, can be confirmed as well.

Referring back to FIG. 3, the SFD detection device 313 detects the SFD in the preamble portion of the received signal to determine the boundary of the data portion, and after the SFD detection is completed, the data processing circuit 320 continues to process the data portion of the received signal based on the boundary of the data portion and the channel parameter information. The data processing circuit 320 may comprise a demodulation device 321, an equalizer 322, and a decoder 323. The demodulation device 321 performs demodulation operations on the PHR and PHY_Payload for each transmission path according to the channel parameter information to generate a data demodulation result associated with each transmission path.

More specifically, the demodulation device 321 may perform demapping and descrambling operations on the received data for different transmission paths according to the SFD boundary and respective time delay. Taking FIG. 4 as an example, a symbol period of the physical header PHR and physical payload PHY_Payload may be divided into four time intervals, where two time intervals are guard periods without data, and the remaining two time intervals may carry data. For example, the 1-block shown in FIG. 4 carries data (thus is drawn with UWB pulse) and the 0-block does not carry data. The UWB pulse may be modulated by scrambling code to suppress interference between users, and the polarity (i.e., positive or negative) and position of the UWB pulse may be determined by encoded bits. Therefore, the demodulation device 321 may perform demapping on the data portion according to the known encoding scheme (pattern) to extract the corresponding data from the positions containing data, and perform descrambling operations based on the known scrambling code to restore the actual data transmitted by the transmitter.

If multiple transmission paths are identified during the channel estimation process, for example, N>1 in the example in FIG. 3, after demapping and descrambling operations, a Rake combination may be used in the operations of multipath data combination to obtain multipath gain. In the embodiments of the invention, the equalizer 322 may be a Rake Equalizer, and before applying the proposed signal processing method to exclude one or more false paths from identified transmission paths, the equalizer 322 may perform multipath equalization and Rake combination on the data demodulation results associated with N transmission paths based on the channel parameter information.

After performing equalization and combination on the data received from multiple transmission paths, the decoder 323 may further perform corresponding decoding operations on the combined signal to obtain the decoded data.

As described above, according to an embodiment of the invention, the channel estimation device 312 may estimate a plurality of transmission paths of the received signal based on the preamble portion (e.g., the SYNC segment) of the received signal to generate channel parameter information, where the channel parameter information may comprise information regarding the transmission paths. The demodulation device 321 in the data processing circuit 320 may process the data portion of the received signal according to the channel parameter information to generate a data demodulation result associated with each transmission path. The channel parameter information and the data demodulation result associated with each transmission path may be provided to the false path detection circuit 330 to identify and exclude false paths (i.e., aforementioned virtual paths or invalid paths) caused by interference from other users from the identified transmission paths.

According to an embodiment of the invention, the false path detection circuit 330 may determine a characteristic value based on the data demodulation result associated with each transmission path, and determine whether the associated transmission path is a false path based on the characteristic value and the channel parameter information. When determining that the associated transmission path is a false path, the false path detection circuit 330 may update the channel parameter information to generate updated channel parameter information, and provide the updated channel parameter information to the data processing circuit 320, where the updated channel parameter information does not comprise information regarding the transmission path being determined as a false path.

According to an embodiment of the invention, the false path detection circuit 330 may comprise an energy estimation device 331 that calculates a signal energy for each transmission path based on the data demodulation result associated with the transmission path as the characteristic value thereof. For example, the energy estimation device 331 may gather the statistics of energy of the demodulated data (i.e., the data demodulation result) over a period of time or the statistics of energy of multiple pieces of demodulated data for each transmission path as the characteristic value of the transmission path.

According to an embodiment of the invention, the false path detection circuit 330 may further comprise a false path determination and exclusion device 332 that determines whether a transmission path is a false path based on the channel parameter information and the characteristic value of the transmission path. For example, the false path determination and exclusion device 332 may calculate a path energy for each transmission path based on the channel parameter information, calculate a weighted path energy based on a weighting value (e.g., a value greater than 0 but less than 1) and the path energy, and determine whether the weighted path energy is greater than the signal energy of the corresponding transmission path, thereby determining whether the signal energy of the corresponding transmission path is significantly lower than its path energy. When the determination result is ‘yes’, it is determined that the transmission path is a false path. Therefore, when the weighted path energy is greater than the signal energy, the false path determination and exclusion device 332 may determine that the corresponding transmission path is a false path and generate updated channel parameter information.

As another example, the false path determination and exclusion device 332 may also determine whether the path energy of each transmission path is greater than the signal energy of the transmission path, and determine whether the difference between the path energy and signal energy exceeds a threshold to determine whether the signal energy of the corresponding transmission path is significantly lower than its path energy. When the path energy is greater than the signal energy and the difference exceeds the threshold, the false path determination and exclusion device 332 may determine that the corresponding transmission path is a false path and generate updated channel parameter information.

According to an embodiment of the invention, for a true path corresponding to the user (i.e., the transmission path that is correct or actually exists for the local user equipment), a level of the path energy will approximate to the obtained signal energy (considering that the typical application scenario of UWB is a slow-varying channel). Therefore, the false paths misidentified due to interference signals from other users can be effectively identified through energy comparison.

It should be noted that in some embodiments, the energy estimation device 331 and the false path determination and exclusion device 332 may also be integrated into a single device. Therefore, the invention is not limited to any particular implementation.

According to an embodiment of the invention, only few initial data symbols in the data portion is required (e.g., only a portion of symbols of the physical header (PHR) is required, without using all symbols of the PHR) for the false path detection circuit 330 to perform corresponding calculations and determinations to identify false paths. Therefore, in the embodiments of the invention, the data demodulation results gathered as the statics of signal energy may be just the data demodulation results generated based on a portion of symbols of the PHR.

According to an embodiment of the invention, assuming that before updating the channel parameter information, the channel parameter information generated by the channel estimation device 312 comprises channel impulse responses h(0) . . . h(N−1) and time delays Tau(0) . . . . Tau(N−1) respectively corresponding to the N transmission paths. After the false path detection circuit 330 or false path determination and exclusion device 332 identifies one or more false paths caused by interference from other users through the above processing, the updated channel parameter information will be generated after excluding information regarding the one or more false paths from the original channel parameter information. The updated channel parameter information may comprise channel impulse responses h(M0) . . . h(MS) and time delays Tau(M0) . . . . Tau(MS) respectively corresponding to (S+1) transmission paths, where S may be an positive integer smaller than N, indices M0˜MS represent the indices of remaining transmission paths obtained by excluding the false path from the transmission paths, and the letter ‘M’ represents that the indices of the channel impulse response and the time delays have been updated after false path exclusion (that is, the M0-th transmission path after updating the channel parameter information and the 0-th transmission path before updating the channel parameter information may not be the same transmission path).

According to an embodiment of the invention, the demodulation device 321 receives the channel parameter information from the channel estimation device 312 and receives the updated channel parameter information from the false path detection circuit 330. Before receiving the updated channel parameter information, the demodulation device 321 demodulates a portion of the physical header (i.e., a portion of symbols of the PHR) for each transmission path based on the channel parameter information (e.g., channel impulse responses h(0) . . . h(N−1) and time delays Tau(0) . . . . Tau(N−1)) to generate data demodulation result for each transmission path. After receiving the updated channel parameter information, the demodulation device 321 demodulates the remaining portion of the physical header or the physical payload (PHY_Payload) of the data portion for each remaining transmission path obtained by excluding the false path from the transmission paths according to the updated channel parameter information (e.g., channel impulse responses h(M0) . . . h(MS) and time delays Tau(M0) . . . . Tau(MS)) to generate data demodulation result associated with the remaining transmission path.

Similarly, according to an embodiment of the invention, the equalizer 322 receives channel parameter information from the channel estimation device 312 and receives updated channel parameter information from the false path detection circuit 330. Before receiving the updated channel parameter information, the equalizer 322 performs equalization and combination processing on the data demodulation results associated with N transmission paths according to the channel parameter information (e.g., channel impulse responses h(0) . . . h(N−1) and time delays Tau(0) . . . . Tau(N−1)). After receiving the updated channel parameter information, the equalizer 322 performs equalization and combination processing on the data demodulation results associated with the remaining (S+1) transmission paths obtained by excluding the false path from the transmission paths according to the updated channel parameter information (e.g., channel impulse responses h(M0) . . . h(MS) and time delays Tau(M0) . . . . Tau(MS)).

According to an embodiment of the invention, after excluding information related to false paths from the channel parameter information and generating updated channel parameter information, the false path detection circuit 330 may be turned off or may no longer operate.

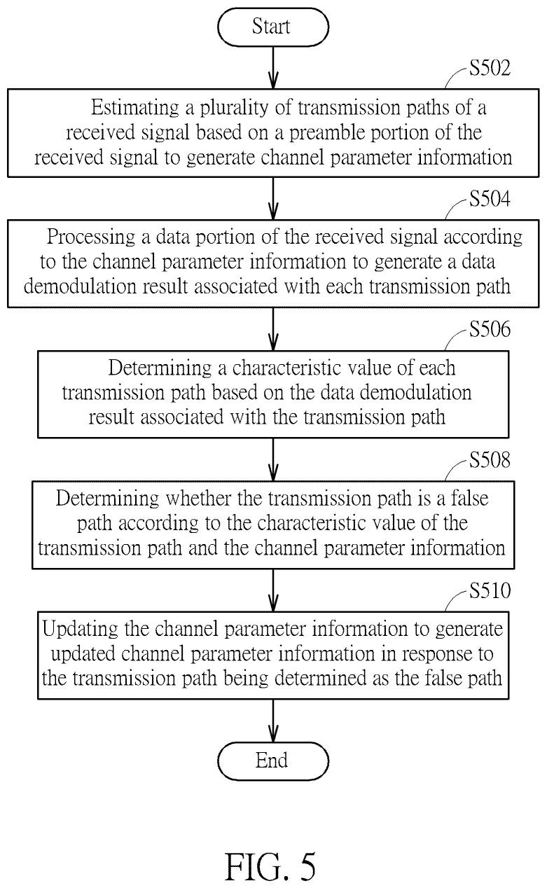

FIG. 5 shows an exemplary flow chart of a signal processing method according to an embodiment of the invention. The signal processing method may be performed by the signal processing circuit 300 and comprise the following steps:

Step S502: estimating a plurality of transmission paths of a received signal based on a preamble portion of the received signal to generate channel parameter information. According to an embodiment of the invention, the channel parameter information comprises information regarding the transmission paths.

Step S504: processing a data portion of the received signal according to the channel parameter information to generate a data demodulation result associated with each transmission path.

Step S506: determining a characteristic value of each transmission path based on the data demodulation result associated with the transmission path.

Step S508: determining whether the transmission path is a false path according to the characteristic value of the transmission path and the channel parameter information.

Step S510: updating the channel parameter information to generate updated channel parameter information in response to the transmission path being determined as the false path. According to an embodiment of the invention, the updated channel parameter information does not comprise information regarding the transmission path being determined as the false path (i.e., the information regarding the transmission path being determined as the false path has been excluded). On the other hand, in response to the transmission path being determined as not a false path, there is no need to exclude information regarding the transmission path from the channel parameter information (i.e., no need to update the channel parameter information).

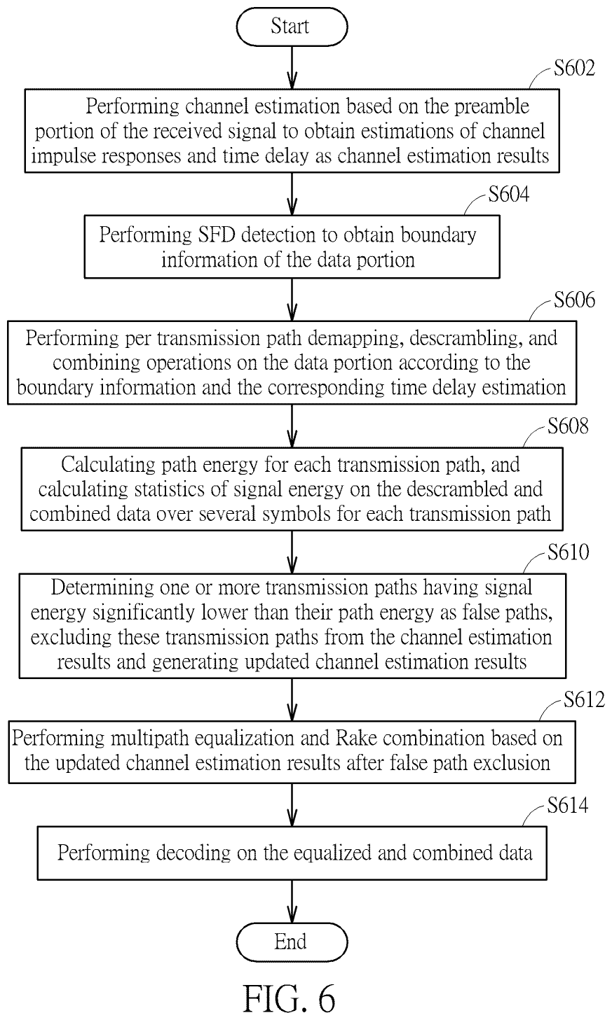

FIG. 6 shows another exemplary flow chart of a signal processing method according to an embodiment of the invention. The signal processing method may be performed by the signal processing circuit 300 and comprise the following specific steps (wherein the steps in general signal processing that are less relevant to this invention are omitted):

Step S602: performing channel estimation based on the preamble portion of the received signal to obtain channel parameter information such as estimations of channel impulse responses and time delay as channel estimation results.

Step S604: performing SFD detection to obtain boundary information of the data portion.

Step S606: performing per transmission path demapping, descrambling, and combining operations on the data portion according to the boundary information and the corresponding time delay estimation.

Step S608: calculating path energy for each transmission path, and calculating statistics of signal energy on the descrambled and combined data over several symbols for each transmission path. According to an embodiment of the invention, assuming the channel impulse response of the m-th path is h(m), its corresponding path energy may be |h(m)|\hat{ }2, and the statistics of signal energy is DE.

Step S610: determining one or more transmission paths having signal energy significantly lower than their path energy as false paths, excluding these transmission paths from the channel estimation results (e.g., the aforementioned channel parameter information), and generating updated channel estimation results. According to an embodiment of the invention, a weighting value Thrd which is greater than 0 but less than 1 may be set, and whether the signal energy DE is less than the weighted path energy Thrd*|h(m)|\hat{ }2 may be determined. When the determination result is ‘yes’, it is determined that the transmission path is a false path.

Step S612: processing subsequently received data according to the updated channel estimation results (i.e., the aforementioned updated channel parameter information) obtained in step S610, including performing multipath equalization and Rake combination based on the updated channel estimation results after false path exclusion.

Step S614: performing decoding on the equalized and combined data.

In the embodiments of the invention, the false paths can be effectively excluded from the identified transmission paths by performing steps S608 and S610 on only several data symbols (e.g., a portion of symbols of PHR) at the beginning of the data portion. Therefore, there is no need to perform steps S608 and S610 on the entire data portion. By excluding false paths, ineffective data combinations on the false paths can be avoided, thereby improving the effective signal-to-noise ratio and enhancing reception performance of the local user equipment.

For example, in the application scenario of UWB frequency channel 9, when the length of ternary code is 31, there are only two valid code indices. When multiple devices coexist, there is a considerable probability for preamble signal collision to occur (i.e., identical preamble signals, which is a condition for a false path to be generated). When the length (L) of inserting zero is also the same, these colliding devices will have the same symbol period as the local user equipment. In such scenario, it would be difficult to suppress interference in preamble signal through multi-symbol combination when the proposed signal processing method is not applied, resulting in false paths from other users exist in the channel estimation result obtained based on preamble signals.

The proposed signal processing method can accurately identify and exclude false paths from the identified transmission paths, even in severe collision scenarios where the colliding devices have the same code index (CodeIndex) and the same length (L) as the local user equipment. Therefore, the problem of degraded reception performance due to the presence of false paths can be effectively solved.

Furthermore, generally, due to the periodicity of symbols in SYNC segment, the difference in time delay of the channels estimated through channel estimation will be within one symbol. Therefore, even if the time delay difference exceeds one symbol, it will be estimated as a difference within one symbol. The only scenario where the proposed signal processing method would fail is when the reference scrambling code and data position of the local user equipment match with the actual scrambling code and data position in the interference signal from other users, but the probability of this condition being met is far lower than the aforementioned probability of preamble signal collision. Therefore, even though there exist possible failure scenarios for the proposed signal processing method, since the probability of such scenarios occurring is far lower than the probability of preamble signal collision, the proposed signal processing method is still highly valuable in application.

More specifically, if the SFD of a target user (i.e., the local user equipment) can be correctly detected, when retrieving data based on the position of detected SFD and estimated time delay of false paths, there exists a non-zero but extremely small probability that the reference scrambling code and data position will match with the actual scrambling code and data position in the interference signal from other users, where the conditions required for the matching to occur includes: the data symbol in the SYNC segment of the interference user and target user are the same, the difference between the start positions of the PHR of interference user and target user is within one preamble signal symbol, for BPM-BPSK (Burst Position Modulation-Binary Phase Shift Keying) users, the interference user and target user must have the same PHR average Pulse Repetition Frequency (PRF) and data rate, and for HPRF (High Pulse Repetition Frequency) users, the interference user and target user must have the same PHR average PRF.

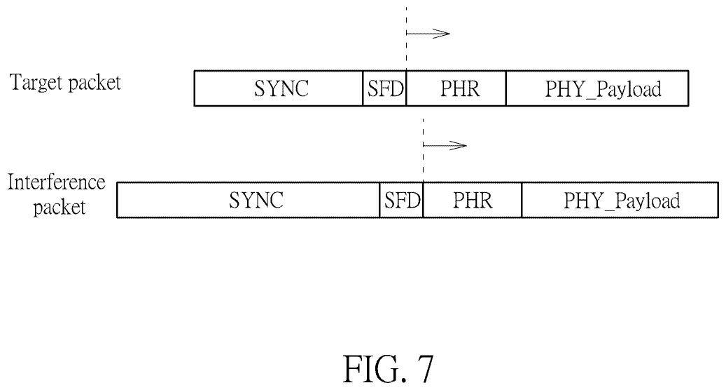

FIG. 7 shows a schematic diagram of a failure scenario. When the interference packet from an interference user has the same symbol data in SYNC segment as the target packet from the target user, the difference in start positions of the PHR is within one symbol of the preamble signal, and the PRF and data rate of the PHR are the same, it becomes difficult to identify false paths came from the interference user using the proposed signal processing method. However, the probability of this scenario to occur is actually much lower than the probability of preamble signal collision.

Conversely, when any of the aforementioned conditions required for the matching to occur is not met, since either the data position or scrambling code does not accurately align with the actual values, the signal energy obtained after performing descrambling and demodulation based on the estimated time delay of the false path will be lower than the path energy of the false path. Therefore, false paths from interference users can all be effectively identified using the proposed signal processing method.

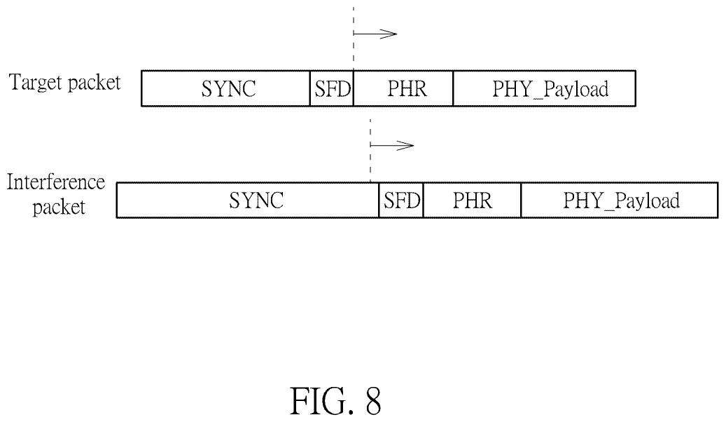

FIG. 8 shows a schematic diagram of a scenario where the proposed signal processing method is applied to identify false paths due to interference signals from other users. In this example, the interference user and target user have the same content in SYNC segment symbols and the same PHR. The dotted line connected to the interference packet at the bottom represents the start position of the PHR estimated according to the false path, which shows that the time difference between the PHR start positions of the interference packet from the interference user and the target packet from the target user exceeds one SYNC segment symbol. In this scenario, even though the interference user and target user have the same content in SYNC segment symbols and the same PHR, false paths from the interference user can still be identified using the proposed signal processing method.

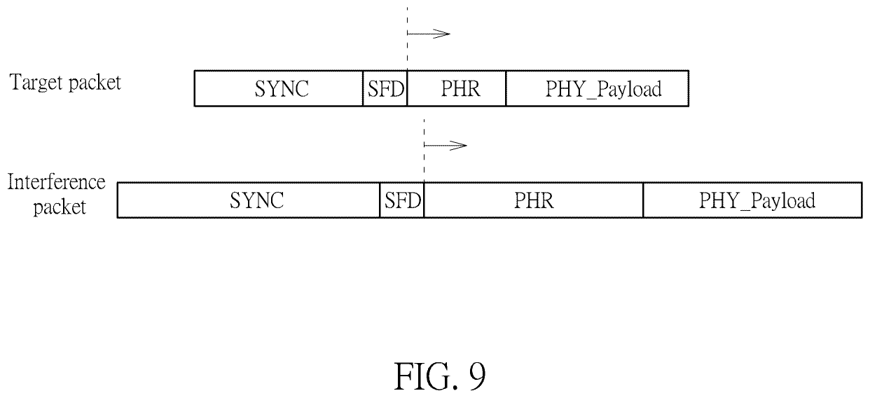

FIG. 9 shows another schematic diagram of a scenario where the proposed signal processing method is applied to identify false paths due to interference signals from other users. In this example, even though the interference user and target user have the same content in SYNC segment symbols and the time difference in PHR start position is within one SYNC segment symbol, false paths from the interference user can still be identified using the proposed signal processing method.

Furthermore, when the SFD of the interference user differs from that of the target user, even if the SFD of the interference user arrives before the SFD of the target user and the time difference in PHR start position exceeds one SYNC segment symbol, false paths from the interference user can still be identified using the proposed signal processing method.

In summary, when demodulating the data portion, since the data received via the false paths does not contain data of the target user, ineffective information will be incorporated in when performing equalization operations using channel estimation that includes false paths, resulting in degraded reception performance. Through the processing of the data portion by applying the proposed signal processing method, false paths misidentified or mistakenly determined in channel estimation can be effectively identified and excluded, thereby improving reception performance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A signal processing circuit, comprising:
a channel estimation device, estimating a plurality of transmission paths of a received signal based on a preamble portion of the received signal to generate channel parameter information, wherein the channel parameter information comprises information regarding the transmission paths;
a data processing circuit, processing a data portion of the received signal according to the channel parameter information to generate a data demodulation result associated with each transmission path; and
a false path detection circuit, determining a characteristic value of each transmission path based on the data demodulation result associated with the transmission path, determining whether the transmission path is a false path according to the characteristic value of the transmission path and the channel parameter information, and in response to the transmission path being determined as the false path, updating the channel parameter information to generate updated channel parameter information and providing the updated channel parameter information to the data processing circuit,
wherein the updated channel parameter information does not comprise information regarding the transmission path being determined as the false path.

2. The signal processing circuit of claim 1, wherein the false path detection circuit comprises:
an energy estimation device, calculating a signal energy for each transmission path as the characteristic value based on the data demodulation result associated with the transmission path.

3. The signal processing circuit of claim 2, wherein the false path detection circuit further comprises:
a false path determination and exclusion device, calculating a path energy for each transmission path based on the channel parameter information, calculating a weighted path energy based on a weighting value and the path energy, and determining whether the weighted path energy is greater than the signal energy of the transmission path,
wherein in response to the weighted path energy being greater than the signal energy of the transmission path, the false path determination and exclusion device determines that the transmission path is the false path, and generates the updated channel parameter information.

4. The signal processing circuit of claim 1, wherein the data demodulation result is generated based on a portion of symbols of a physical header of the data portion.

5. The signal processing circuit of claim 1, wherein the information regarding the transmission paths comprises a time delay and a channel impulse response corresponding to each of the transmission paths.

6. The signal processing circuit of claim 1, wherein the data processing circuit comprises:
a demodulation device, receiving the channel parameter information from the channel estimation device, and receiving the updated channel parameter information from the false path detection circuit,
wherein before receiving the updated channel parameter information, the demodulation device demodulates a portion of a physical header of the data portion for each transmission path according to the channel parameter information to generate the data demodulation result associated with the transmission path, and
after receiving the updated channel parameter information, the demodulation device demodulates remaining portion of the physical header or a physical payload of the data portion for a remaining transmission path obtained by excluding the false path from the transmission paths according to the updated channel parameter information to generate the data demodulation result associated with the remaining transmission path.

7. The signal processing circuit of claim 1, wherein the data processing circuit comprises:
an equalizer, receiving the channel parameter information from the channel estimation device, and receiving the updated channel parameter information from the false path detection circuit,
wherein before receiving the updated channel parameter information, the equalizer performs equalization and combination processing on the data demodulation results associated with the transmission paths according to the channel parameter information, and
after receiving the updated channel parameter information, the equalizer performs the equalization and combination processing on the data demodulation results associated with one or more remaining transmission paths obtained by excluding the false path from the transmission paths according to the updated channel parameter information.

8. The signal processing circuit of claim 1, further comprising:
a start-of-frame delimiter (SFD) detection device, detecting an SFD of the preamble portion of the received signal to determine a boundary of the data portion, wherein the data processing circuit processes the data portion of the received signal further according to the boundary.

9. A signal processing method, comprising:
estimating a plurality of transmission paths of a received signal based on a preamble portion of the received signal to generate channel parameter information, wherein the channel parameter information comprises information regarding the transmission paths;
processing a data portion of the received signal according to the channel parameter information to generate a data demodulation result associated with each transmission path;
determining a characteristic value of each transmission path based on the data demodulation result associated with the transmission path;
determining whether the transmission path is a false path according to the characteristic value of the transmission path and the channel parameter information; and
in response to the transmission path being determined as the false path, updating the channel parameter information to generate updated channel parameter information,
wherein the updated channel parameter information does not comprise information regarding the transmission path being determined as the false path.

10. The signal processing method of claim 9, wherein step of determining the characteristic value of each transmission path based on the data demodulation result associated with the transmission path further comprises:
calculating a signal energy for the transmission path as the characteristic value based on the data demodulation result associated with the transmission path.

11. The signal processing method of claim 10, wherein step of determining whether the transmission path is the false path according to the characteristic value of the transmission path and the channel parameter information further comprises:
calculating a path energy for the transmission path based on the channel parameter information;
calculating a weighted path energy based on a weighting value and the path energy; and
determining whether the weighted path energy is greater than the signal energy of the transmission path;
wherein in response to the weighted path energy being greater than the signal energy of the transmission path, the transmission path is determined as the false path.

12. The signal processing method of claim 9, wherein the data demodulation result is generated based on a portion of symbols of a physical header of the data portion.

13. The signal processing method of claim 9, wherein the information regarding the transmission paths comprises a time delay and a channel impulse response corresponding to each of the transmission paths.

14. The signal processing method of claim 9, wherein step of processing the data portion of the received signal according to the channel parameter information to generate the data demodulation result associated with each transmission path further comprises:
demodulating a portion of a physical header of the data portion for the transmission path according to the channel parameter information to generate the data demodulation result associated with the transmission path, and
after the channel parameter information is updated, the signal processing method further comprises:
demodulating remaining portion of the physical header or a physical payload of the data portion for a remaining transmission path obtained by excluding the false path from the transmission paths according to the updated channel parameter information to generate the data demodulation result associated with the remaining transmission path.

15. The signal processing method of claim 9, wherein step of processing the data portion of the received signal according to the channel parameter information to generate the data demodulation result associated with each transmission path further comprises:
performing equalization and combination processing on the data demodulation results associated with the transmission paths according to the channel parameter information, and
after the channel parameter information is updated, the signal processing method further comprises:
performing the equalization and combination processing on the data demodulation results associated with one or more remaining transmission paths obtained by excluding the false path from the transmission paths according to the updated channel parameter information.
